(19) United States
(12) Patent Application Publication
(10) Pub. No.: US 2015/0321265 A1
(43) Pub. Date: Nov. 12, 2015

(54) COLLET

(71) Applicant: DAIDO STEEL CO., LTD., Aichi (JP)

(72) Inventors: Fumihito SAKURAI, Gunma (JP); Kenji WATANABE, Aichi (JP); Michiya MOHRI, Aichi (JP)

(73) Assignee: DAIDO STEEL CO., LTD., Aichi (JP)

(21) Appl. No.: 14/652,239

(22) PCT Filed: Feb. 3, 2014
(86) PCT No.: PCT/JP2014/052445

§ 371 Date: Jun. 15, 2015

(30) Foreign Application Priority Data
Feb. 14, 2013 (JP) 2013-026476

(51) Int. Cl. B23B 31/20

(52) U.S. Cl. CPC B23B 31/202; B23B 2250/16

(57) ABSTRACT

Provided is a collet in which a rod made of a damping alloy is fitted and embedded in a long hole of a cylinder-shaped body portion having a central axis, which is provided by drilling in a direction parallel to the central axis, from an end surface on an insertion opening side through which a member to be fixed is inserted.

### TECHNICAL FIELD

The present invention relates to a collet which is mounted on a holder or a chuck (hereinafter, referred to simply as a “chuck”) fixed to a machine tool and to which an end portion of a rotary cutting tool, such as an end mill, or a workpiece to be rotationally cut is fixed; and particularly, relates to a collet having a vibration-damping function for suppressing vibration during an operation.

### BACKGROUND ART

A collet is used when mounting, on a chuck of a machine tool, a rotary cutting tool, such as an end mill, or a rod-shaped workpiece which is subjected to rotation and cutting processing. Generally, an end portion of the rod-shaped rotary cutting tool or the workpiece to be rotationally cut is inserted into a cylinder-shaped body portion of the collet, and then this is mounted on the chuck and is tightened up from the outer circumferential side, to thereby be fixed to the machine tool. A case in which a cutting tool is mounted on the machine tool will be described below. However, even in a case in which a workpiece is mounted, the same can be applied as long as there is no specific notification.

When cutting processing is performed, it is necessary to mount, with high accuracy, a cutting tool on a machine tool in order to enhance processing accuracy of a workpiece to be cut. Particularly, in the case of a rod-shaped cutting tool which is fixed to a chuck via a collet, it is important to enhance vibration accuracy of a tip end portion, which is located far away from the chuck by a predetermined distance in a direction directed to a cutting edge.

Meanwhile, Patent Document 1 for example, describes that even in a chuck having high accuracy a tip end portion thereof has a vibration accuracy of 3 μm to 5 μm, and discloses a collet in which a correcting screw is provided to correct vibration of a cutting edge of a tool. Specifically, the collet is a cylinder-shaped body portion having a central axis and has a disk-shaped flange portion on an insertion opening side through which a shank portion of a rotary cutting tool, such as an end mill, is inserted. In the flange portion, at a plurality of positions in a circumferential direction thereof, screw holes which pass through the flange portion in a direction parallel to an axis line of the shank portion of the tool are provided, and vibration correcting screws are screwed thereinto to protrude from a rear surface of the flange portion. The collet is accommodated and fixed in the chuck cylinder, but when the vibration correcting screw is operated in a screwing direction in a stopped state before cutting processing is performed, a tip end portion thereof abuts on a circumferential edge portion of the chuck cylinder. It is said that a base portion of the shank portion of the tool is elastically deformed in a direction in which the amount of vibration of the cutting edge of the tool approaches zero, by increasing/reducing a pressing force of the vibration correcting screw against the circumferential edge portion of the chuck cylinder, thereby the vibration of the cutting edge of the tool can be corrected. In other words, the vibration correcting screw abuts on the circumferential edge portion of the chuck cylinder in a state where a workpiece to be cut is not in contact with the tool, thereby the vibration of the cutting edge of the tool is suppressed.

Furthermore, in many cases, vibration which is generated by, for example, change in a contact pressure between a cutting tool and a workpiece to be cut during cutting processing reduces the processing accuracy of the workpiece to be cut. Then, it is considered that a collet, a chuck, or the like is made of a damping alloy such that vibration generated in a cutting tool and/or a workpiece is absorbed.

A twin-crystal-type Mn-based damping alloy suitable for manufacturing a tool for machining is disclosed in Patent Document 2, for example. The alloy has a component composition containing, in a % by mass basis, Cu: 16.9-27.7%, Ni: 2.1-8.2%, Fe: 1.0-2.9%, C: 0.05% or less, O: 0.06% or less, and N: 0.06% or less, with the balance being Mn and unavoidable impurities; and it has good twin-crystal deformation responsivity with respect to the application of stress and has excellent vibration-damping properties. In addition, since it can satisfactorily maintain the vibration-damping properties in an area in which the amount of distortion is large, has a high mechanical strength and is excellent in molding processability and welding properties, it is suitable for manufacture of tool for mechanical machining.

### CITATION LIST

### Patent Documents

Patent Document 1: JP-A-2003-245837

Patent Document 2: JP-A-2003-253369

### SUMMARY OF INVENTION

### Technical Problem

When a collet, a chuck, or the like is made of a damping alloy, vibration generated in a cutting tool and/or a workpiece can be absorbed. On the other hand, since a damping alloy, such as the twin-crystal-type Mn-based damping alloy described above, generally does not have rigidity as high as that of a tool steel, and thus, it does not necessarily enhance the processing accuracy of a workpiece to be cut though it absorbs vibration.

There is a demand, in terms of production efficiency in cutting processing, to extend a life span of a cutting tool while reducing abrasion rate of a cutting edge, and this is also influenced by a collet. Particularly, in a case of a cutting tool, such as an end mill, since cutting is performed in three-axis of XYZ directions, severe abrasion occurs, and thus the demand described above is significant in a collet for an end mill.

The present invention was made in view of such circumstances, and an object thereof is to provide a collet which has a vibration-damping function capable of enhancing processing accuracy of a workpiece to be cut and can reduce the abrasion amount of a cutting edge of a cutting tool to be used.

### Means for Solving Problem

The collet according to the present invention is that a rod made of a damping alloy is fitted and embedded in a long hole of a cylinder-shaped body portion having a central axis, which is provided by drilling in a direction parallel to the central axis from an end surface on an insertion opening side through which a member to be fixed is inserted.

That is, the present invention relates to the following [1] to [5].

[1]

A collet containing:

a cylinder-shaped body portion having a central axis, and a rod made of a damping alloy,

in which, the cylinder-shaped body portion having the central axis has a long hole provided by drilling in a direction parallel to the central axis from an end surface on an insertion opening side through which a member to be fixed is inserted, and

in which the rod made of a damping alloy is fitted and embedded in the long hole.

[2]

The collet according to [1],

in which an inner circumferential surface of the long hole and an outer circumferential surface of the rod are subjected to screw-thread cutting and the rod is screwed into the long hole.

[3]

The collet according to [1] or [2],

in which slits are provided from the end surface such that the cylinder-shaped body portion is divided at equal angles around the central axis to a plurality of gutter-shaped pieces, and

in which, in each of the gutter-shaped pieces, the long hole is provided at the same corresponding position and the rod is given.

[4]

The collet according to [3],

in which an odd number of the slits are provided, and

in which, in each gutter-shaped piece, at a position symmetric with respect to an imaginary plane passing through the slit facing an inner surface thereof and the central axis, the long hole is provided and the rod is given.

[5]

The collet according to any one of [1] to [4],

in which the damping alloy has a component composition containing, in a % by mass basis,

Cu: 16.9-27.7%,

Ni: 2.1-8.2%,

Fe: 1.0-2.9%, and

C: 0.05% or less,

with the balance being Mn and unavoidable impurities.

### Advantageous Effects of Invention

According to the present invention, when the workpiece to be cut is in contact with the cutting tool during cutting processing, the vibration generated in the cutting tool and/or the workpiece is absorbed by the damping alloy. In addition, mechanical strength required for a collet can be ensured. Thus, the processing accuracy of the workpiece to be cut can be enhanced and the abrasion amount of the cutting edge of the cutting tool can be reduced.

In the invention described above, an inner circumferential surface of the long hole and an outer circumferential surface of the rod may be subjected to screw-thread cutting and the rod may be screwed into the long hole. According to this invention, the vibration which is generated in the cutting tool and/or the workpiece during an operation can be more effectively absorbed. In addition, the processing accuracy of the workpiece to be cut can be more enhanced and the abrasion amount of the cutting edge of the cutting tool can be reduced.

In the invention described above, slits may be provided from the end surface such that the cylinder-shaped body portion is divided at equal angles around the central axis to a plurality of gutter-shaped pieces, and in each of the gutter-shaped pieces, the long hole may be provided at the same corresponding position and the rod may be given. According to this invention, the vibration which is generated in the cutting tool and/or the workpiece during the operation can be more effectively absorbed. In addition, the processing accuracy of the workpiece to be cut can be greatly enhanced and the abrasion amount of the cutting edge of the cutting tool can be reduced.

In the invention described above, an odd number of the slits may be provided, and in each gutter-shaped piece, at a position symmetric with respect to an imaginary plane passing through the slit facing an inner surface of the gutter-shaped piece and the central axis, the long hole may be provided and the rod may be given. According to this invention, the vibration which is generated in the cutting tool and/or the workpiece during the operation can be more effectively absorbed. In addition, the processing accuracy of the workpiece to be cut can be greatly enhanced and the abrasion amount of the cutting edge of the cutting tool can be reduced.

In the invention described above, the damping alloy may have a component composition containing, in a % by mass basis, Cu: 16.9-27.7%, Ni: 2.1-8.2%, Fe: 1.0-2.9%, and C: 0.05% or less, with the balance being Mn and unavoidable impurities. According to this invention, the vibration which is generated in the cutting tool and/or the workpiece during the operation can be more effectively absorbed. In addition, the processing accuracy of the workpiece to be cut can be greatly enhanced and the abrasion amount of the cutting edge of the cutting tool can be reduced.

### BRIEF DESCRIPTION OF DRAWINGS

FIG. 1 a side view (a) and a front view (b) of an example of a collet according to the present invention.

FIG. 2 a cross-sectional side view of the periphery of a chuck in a state where an example of the collet of the preset invention is mounted thereon.

FIG. 3 a side view (a) and a front view (b) of another example of a collet according to the present invention.

FIG. 4 a perspective view illustrating a cutting method in a cutting test.

FIG. 5 diagrams showing a measurement result of a surface roughness in the cutting test.

FIG. 6 diagrams showing tool marks in the cutting test.

FIG. 7 views illustrating a cross-sectional shape of a workpiece in the cutting test.

FIG. 8 a view illustrating a measurement method of an abrasion area of a cutting edge of an end mill.

FIG. 9 diagrams showing the abrasion state of a cutting edge of an end mill in the cutting test.

### MODE FOR CARRYING OUT THE INVENTION

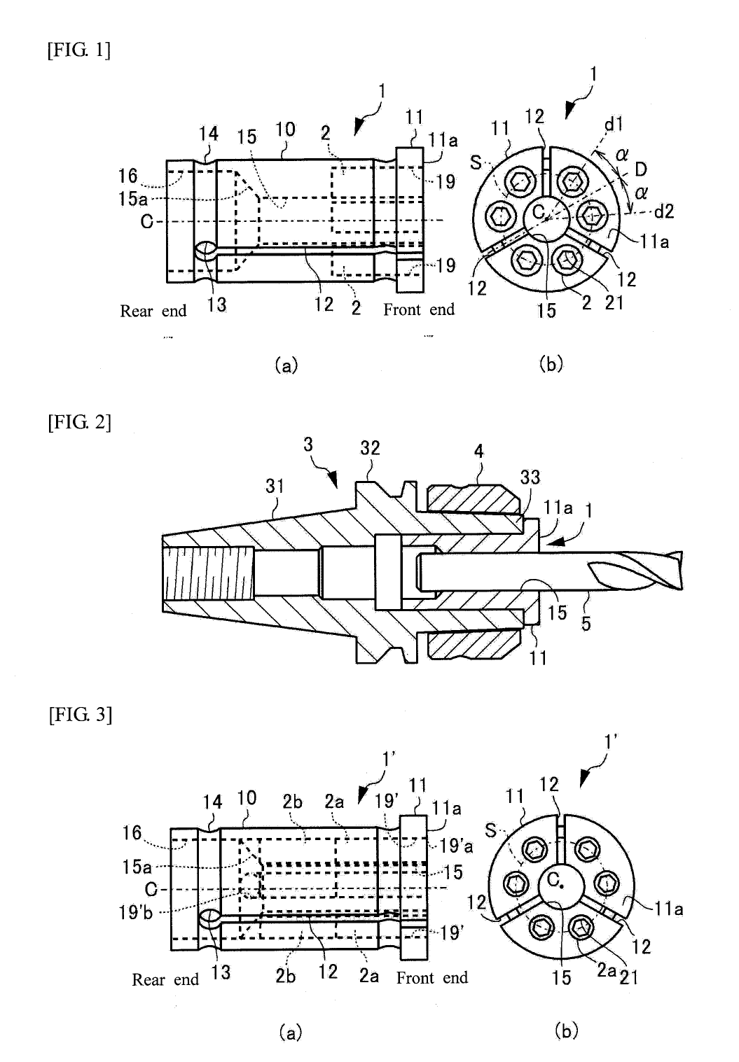

Details of a collet for a machine tool, as an example of the present invention, will be described with reference to FIG. 1 and FIG. 2.

A collet 1 is a straight collet, as illustrated in FIG. 1, and has a shape in which a flange portion 11 protruding in an outer circumferential direction is provided in an end portion on a front end side of a body portion 10 having a substantially cylindrical shape, in other words, on a side (see FIG. 2; a side of the body portion 10, opposite to the side in which the end mill 5 is to be inserted, will be referred to as a “rear end side”) in which an end mill 5 described below is to be inserted. On the inner surface of the cylinder portion of the body portion 10 having a cylindrical shape, a step is provided in a direction along a central axis C. A clearance hole portion 16 which is provided on the rear end side and has a large diameter and a gripping portion 15 which is provided on the front end side and has a small diameter are connected via a stepped portion 15a which is inclined.

Around the outer circumference of the body portion 10, an outer circumferential groove 14, which extends circumferentially and has a gutter shape, is provided at a position which is located apart from the rear end by a predetermined distance. In the outer circumferential groove 14, at equal interval positions therealong, provided are slit windows 13, which are holes extending from the outer circumferential groove 14 to the clearance hole portion 16. From each slit window 13 provided are slit grooves 12, which each has a slit shape and extends in a direction substantially parallel to the central axis C to an end surface 11a of the flange portion 11 of the front end side. Since such slit grooves 12 are provided, the body portion 10 of the collet 1 includes gutter-shaped pieces which are divided at equal intervals in the circumferential direction and an integral portion which connects them and is located further on the rear end side than the outer circumferential groove 14. Though the configuration is not limited thereto, FIG. 1 illustrates the collet 1 having a configuration in which the slit grooves 12 are provided to divide the end surface 11a on the front end side into three portions at 120° and three gutter-shaped pieces are provided in the body portion 10. The front end side of each gutter-shaped piece can be bent in a radial direction with the outer circumferential groove 14 as a fulcrum.

In the body portion 10, long holes 19 which extend in a direction parallel to the central axis C and has an opening in the end surface 11a on the front end side is formed in a drilled manner. Particularly, a plurality of long holes 19 are provided on a circle S centered at the central axis C in the end surface 11a having a circular shape such that they are provided at the same positions in the respective gutter-shaped pieces (with regard to the circle S, see (b) of FIG. 1), as illustrated in (a) of FIG. 1. In other words, the arrangements of the long holes 19 in the respective gutter-shaped pieces are the same. For example, in each gutter-shaped piece which has a sectral cross-sectional shape and is defined by the slit grooves 12 which are provided to divide the end surface 11a having a circular shape into three portions at 120°, two long holes 19 are provided at symmetric positions (on straight lines d1 and d2 and the circle S) by the same angle α on both sides to interpose a dividing line D dividing the gutter-shaped piece into two portions. In other words, six long holes 19 are drilled in the collet 1 having the body portion 10 which includes the three gutter-shaped pieces. When odd number of slit grooves 12 are arranged at equal angles, as described above, the dividing line D passes through the center of the slit groove 12 facing the inner surface of the gutter-shaped piece. Accordingly, the long holes 19 which are disposed in the gutter-shaped piece on the upper right side of the drawing are also symmetrically arranged with respect to an imaginary plane passing through both the slit groove 12 on the lower left side of the drawing and the central axis C.

The material used for the body portion 10 is not particularly limited. For example, use can be made of a high carbon chromium bearing steel, carbon steel for machine construction, a chromium steel, and a chromium molybdenum steel.

A rod 2 made of a damping alloy is embedded in each long hole 19 provided to the body portion 10 so as to fit to the inner circumferential surface of the long hole 19. In this case, the rod 2 does not protrude from the body portion 10 and is completely embedded thereinto. When the rod 2 is fitted and embedded in the long hole 19, a shrink fitting or an expansion fitting can be considered. However, it is preferable that, simply, a female thread is formed around the inner circumference of the long hole 19 and a male thread is formed around the outer circumference of the rod 2, and then both are screwed to each other. In this case, the rod 2 having a length of approximately the same as the depth of the long hole 19 is prepared and a hexagon hole 21 is drilled in the tip end thereof to provide a lock screw with a hexagon hole, and it is fixed, in a screwed manner, to the long hole 19 to the bottom portion thereof.

For the rod 2 is used a damping alloy which absorbs vibration of the end mill 5 of which the side surface is gripped by the gripping portion 15 as described below. Such vibration mainly generated in a part of the end mill 5, which is the portion in contact with a workpiece to be cut, is transmitted to the rod 2 made of a damping alloy, through the end mill 5 and the gripping portion 15 of the body portion 10 of the collet 1, which have high rigidity, high strength and high hardness. In this case, the damping alloy absorbs the vibration by deforming itself by the vibration to convert the vibration energy into thermal energy. In other words, in order to allow the rod 2 to absorb more vibration, a damping alloy which is likely to be more easily deformed is preferable. In this embodiment is used a twin-crystal-type Mn—Cu—Ni—Fe-based damping alloy, which has low rigidity and thus is to be easily deformed and, further has high damping properties against vibration of a wide frequency range as compared with a general iron-based damping alloy (e.g., an Fe—Cr alloy or an Fe—Al alloy).

Specifically, it is preferable that a damping alloy has a component composition containing, in a % by mass basis, Cu: 16.9-27.7%, Ni: 2.1-8.2%, Fe: 1.0-2.9%, and C: 0.05% or less, with the balance being Mn and unavoidable impurities. Here, the composition ranges (mass % in each) of the respective components of the damping alloy will be simply described. With regard to the composition range of Cu, when equal to or more than 16.9%, it is preferable because twin crystals are easily deformed; whereas when equal to or less than 27.7%, it is preferable because segregation is prevented from becoming large and adequate vibration-damping properties are likely to be obtained. In addition, more preferable composition range of Cu is from 19.7 to 25.0%. With regard to Ni, it is added as a third element in addition to Mn and Cu as main elements, and is capable of improving the vibration-damping properties. In order to obtain such an effect effectively, it is preferable that the composition range of Ni is set to equal to or more than 2.1% and equal to or less than 8.2%. With regard to Fe, it is added as a fourth element in addition to Mn, Cu and Ni, and is capable of more improving the vibration-damping properties. It is preferable that such an effect can be easily obtained when the composition range of Fe is set to be equal to or more than 1.0 mass %; whereas when equal to or less than 2.9%, it is preferable because the effect is not saturated. With regard to C, when the composition range thereof is set to be equal to or less than 0.05%, even when the relative concentration of C increases due to evaporation of Mn or the like, deterioration in the vibration-damping properties can be prevented.

As the damping alloy used for the rod 2, use can be made of an alloy having a young's modulus being in the range of 60 to 90 GPa measured by a dynamic viscoelastic measurement (DMA; Dynamic Mechanical Analysis), and an example thereof is the above-described twin-crystal type Mn—Cu—Ni—Fe-based damping alloy.

The collet 1 is used in a state of being fixed to a chuck 3, as illustrated in FIG. 2. The chuck 3 has a shank portion 31 on one end side, which is mounted on a spindle (not illustrated) of a machine tool, a chuck cylinder 33 on the other end side, and a flange portion 32 disposed therebetween. The collet 1 is inserted into the chuck cylinder 33 from the rear end side thereof, and tightened up by a tightening cylinder 4 via the chuck cylinder 33 of the chuck 3. Accordingly, the collet 1 can fix, by tightening up by the inner circumferential surface of the gripping portion 15, a rod-shaped portion of the end mill 5 as a member to be fixed which is inserted from the end surface 11a side. If necessary, the end mill 5 may be a workpiece to be cut, which has a gripping portion which can be gripped by rotary tools of various types or the collet 1.

According to the collet 1 described above, the vibration generated in the end mill 5 when a machine tool is operated can be effectively absorbed, mechanical strength necessary for a collet can be ensured, the processing accuracy of a workpiece to be cut can be enhanced, and the abrasion amount of a cutting edge of a cutting tool can be reduced.

In the collet 1 of the example described above, three slit grooves 12 are provided at equal intervals and thus the body portion 10 is divided into three portions. However, the interval between the slit grooves and the number of divisions can be appropriately adjusted. Not limited to the straight collet, and also in the case of a tapered collet or a spring collet, the processing accuracy of a workpiece to be cut can be enhanced similarly by fitting and embedding a rod made of the damping alloy in a long hole. Further, the number of pairs of the long hole 19 and the rod 2 made of the damping alloy is not limited to the number described above and plurality of pairs can be appropriately provided in the body portion 10, within the range in which mechanical strength required for a collet is not reduced greatly.

As another example illustrated in FIG. 3, a through-hole 19′ of which both end portions are open can be provided in a collet 1′. Thereto may be fitted and embedded the rod 2 (see FIG. 1), but two members of rods 2a and 2b may be fitted and embedded therein. In the through-hole 19′, one opening 19′a is provided in the end surface 11a and the other opening 19′b is provided in the stepped portion 15a. The opening 19′b is inclined due to the stepped portion 15a, with respect to the axis line of the long hole 19′. Each of the rods 2a and 2b is constituted of a lock screw with a hexagon hole, and they are inserted through the opening 19′a and through the opening 19′b, respectively, and screwed.

In this case, the rod 2b is located at a position at which a rear end surface thereof, which is substantially perpendicular to a longitudinal direction, does not protrude from the stepped portion 15a, that is, at a position close to the gripping portion 15 of the opening 19′b. In this case, the position of the rear end surface of the rod 2b can be easily adjusted by inserting the rod 2b first, and then inserting the rod 2a in a screwed manner. Alternatively, the rear end surface of the rod 2b may be located close to the clearance hole portion 16 of the opening 19′b, in such a manner that the entirety of a long hole 19′ is filled with the rods 2a and 2b. Furthermore, in the case where the clearance hole portion 16 is not provided, the through-hole 19′ has an opening on an end surface on the rear end side of the body portion 10, and the rod 2 (or the rods 2a and 2b) are fitted and embedded therein.

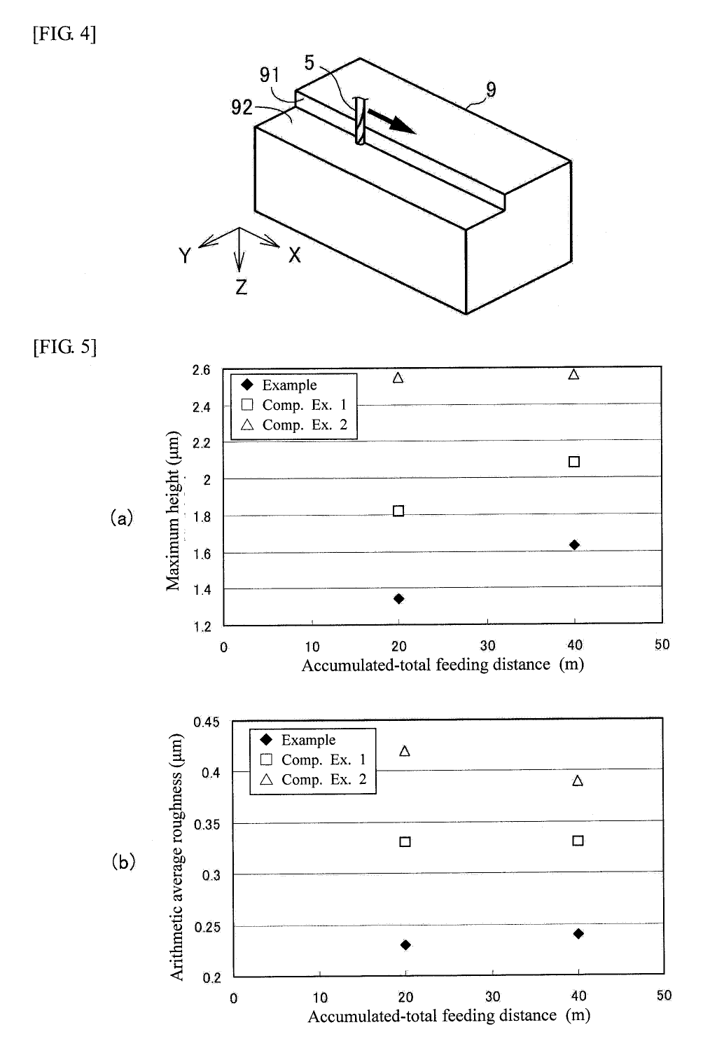

Next, a cutting test and evaluation were performed on the collet 1 described above, that is, the collet 1 in which two of the six rods 2 made of a damping alloy were screwed into each of the three gutter-shaped pieces, each of which was defined by adjacent slit grooves 12. The method of such a cutting test will be described by using FIG. 4, with reference to FIG. 1 and FIG. 2 as needed.

A new end mill 5 (manufactured by Mitsubishi Materials Co., Ltd.; 2MSD1000) which had a blade diameter of 10 mm and was made of cobalt high speed steel (CO HSS) was mounted on a milling machine, which is not illustrated, by using the collet 1 and the chuck 3, and shoulder milling processing was performed on a workpiece 9 which was made of A2024 (duralumin) and had a substantially rectangular shape, as illustrated in FIG. 4. Then, the processing accuracy of cut surfaces 91 and 92 and the abrasion amount of the cutting edge of the end mill 5 were evaluated. The end mill 5 was mounted so as to protrude from the tip end of the gripping portion 15 of the collet 1 by 35.8 mm, the rotation speed was set to 3600 rpm, the cutting depth for each pass was set to 4 mm, the cutting width was set to 0.5 mm, the cutting feed speed was set to 360 mm/min, and the cutting-feeding-direction distance was set to 200 mm. Then, the evaluation of the processing accuracy and the evaluation of the abrasion amount of the cutting edge of the end mill 5, which are described below in detail, were performed for each 100-pass. In this case, an X-axis direction is set to the cutting-feeding direction (the direction toward the lower right side of the paper), a Y-axis direction is set to the cutting-width direction (the direction toward the lower left side of the paper), and a Z-axis direction is set to the protrusion direction (the direction toward the lower side of the paper) of an end mill.

The collet 1 used in the cutting test had a total length of 64.5 mm, an inner diameter of the gripping portion 15 of 10 mm, and an outer diameter of the body portion 10 of 32 mm. Furthermore, the body portion 10 of the collet 1 was made of a high carbon chromium bearing steel (JIS G4805 SUJ2), and for the rod 2 was used a Mn-based Mn—Cu—Ni—Fe-based damping alloy containing, % by mass basis, Cu: 22.4%, Ni: 5.2%, Fe: 2.0%, and C: 0.01%, which had been processed into a lock screw with a hexagon hole of M8 having a length of 22 mm. Here, in the collet 1 in which six rods 2 are fitted and embedded, the volume percent of the damping alloy is preferably set in the range of 5 to 40%. In this Example, it is set to approximately 11.5%.

Meanwhile, in the cutting test, the shoulder milling processing with respect to the workpiece 9 was performed on both a collet (Comparative Example 1) which had the same shape as that of the collet 1 (Example), was not subjected to processing for forming the long hole 19 (in other words, having none of the long hole 19 and the rod 2), and was made of the high carbon chromium bearing steel described above and a collet (Comparative Example 2) which had the same shape as that of the collet 1 (Example), was not subjected to processing for forming the long hole 19 (in other words, having none of the long hole 19 and the rod 2), and was made of the Mn-based Mn—Cu—Ni—Fe-based damping alloy described above. Then, the processing accuracy and the abrasion amount were evaluated.

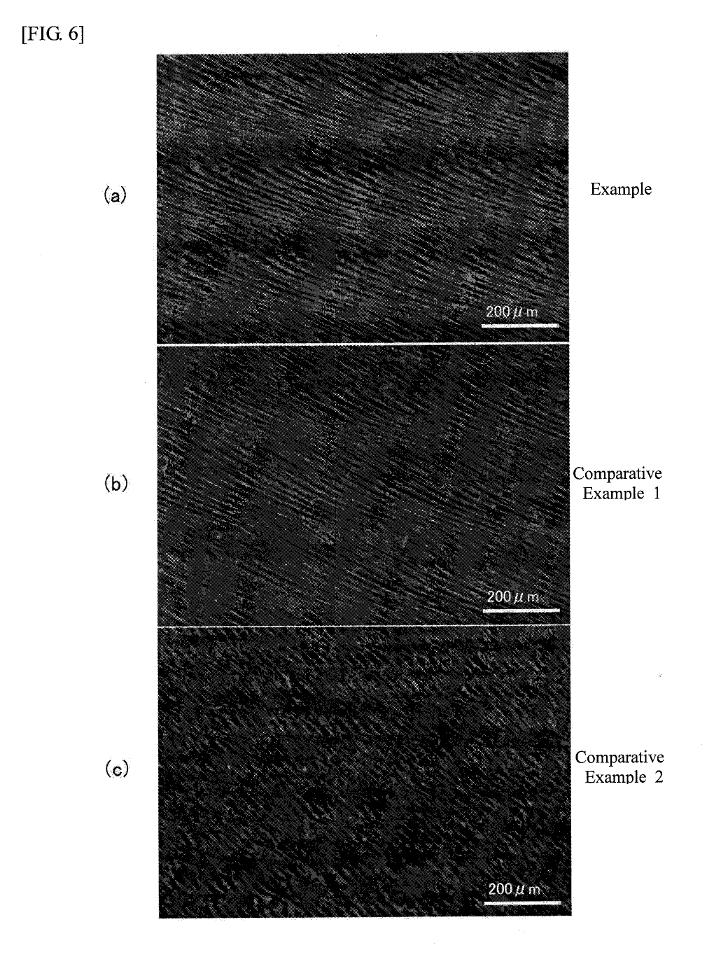

The processing accuracy was evaluated for each 100-pass cutting processing, in other words, by measuring the surface roughness of the cut surface 92 of the workpiece 9, which is the surface perpendicular to the protrusion direction (Z-axis direction) of an end mill, twice at 20 m and 40 m of accumulated-total cutting feed distance. A maximum height (Rmax) and an arithmetic average roughness (Ra) were measured at three positions by using a commercially available surface-roughness measuring device and the average values thereof were employed in the surface-roughness measurement. As for the results, the maximum height (Rmax) is shown in FIG. 5(a) and the arithmetic average roughness (Ra) is shown in FIG. 5(b).

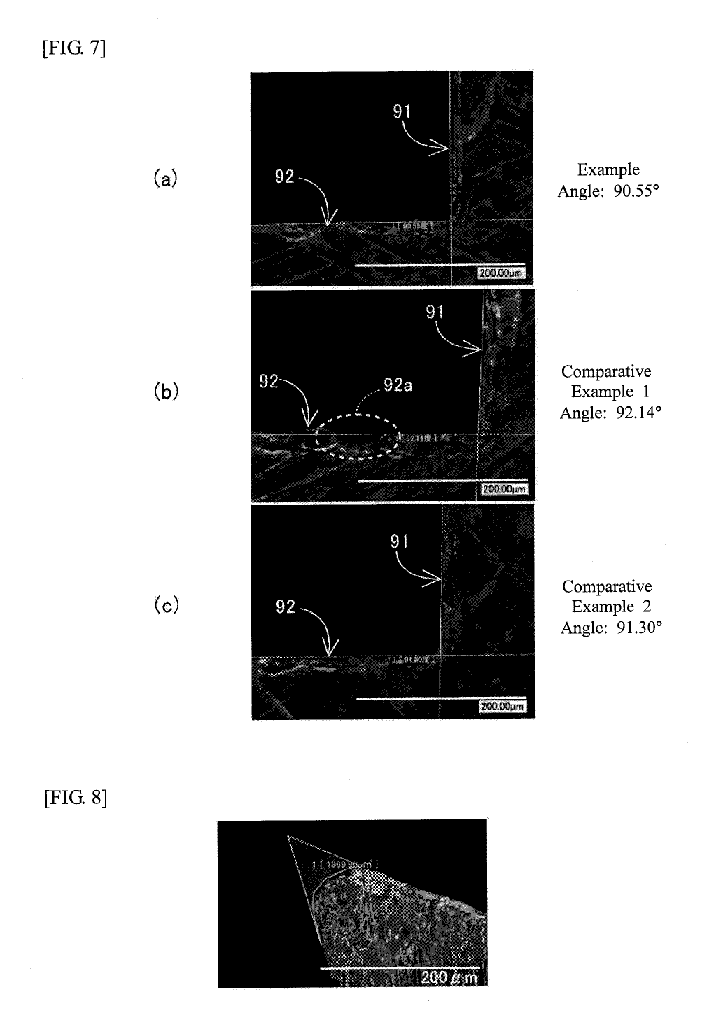

In addition, the processing accuracy was also evaluated by performing visual observation of the cut surface of the workpiece 9 and by measuring the angle of the processed corner portion. Specifically, the tool mark (a cutting trace) of the cut surface 92 was observed by a stereoscopic microscope, at 40 m of the accumulated-total feeding distance. In addition, the workpiece 9 was cut in a plane perpendicular to the cutting-feeding direction (X-axis direction) and a corner portion at which the cut surface 91 perpendicular to the Y-axis direction intersects the cut surface 92 perpendicular to the Z-axis direction was observed by an optical microscope, and then, the angle between the cut surfaces 91 and 92, in other words, the angle between the side surface and the bottom surface which were formed by shoulder milling processing, was measured from a microphotograph. As for the results, appearance photographs (enlarged by 100 times) of the tool marks are shown in FIG. 6 and the appearance photographs and the angles are shown in FIG. 7.

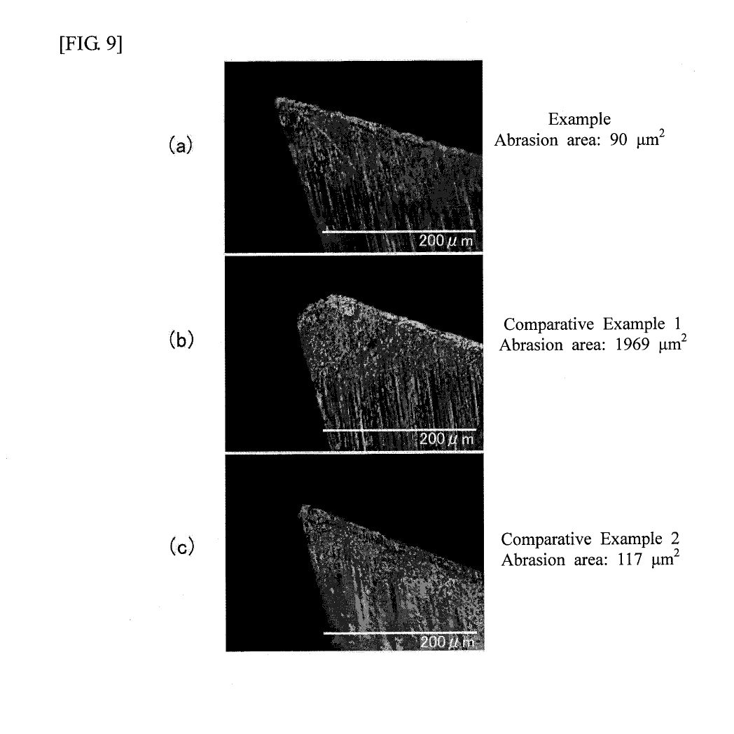

The abrasion amount of the cutting edge of the end mill 5 was evaluated by observing the cutting edge of the end mill 5 by an optical microscope from an flank surface side thereof after the 100-pass cutting processing was finished, in other words, after the accumulated-total feeding distance reaches 20 m, and then calculating the abrasion area of the cutting edge as compared with the shape of a new cutting edge from a microphotograph, as illustrated in FIG. 8. As for the results, the photographs of the cutting edges and the abrasion areas are shown in FIG. 9.

The results of the cutting test described above will be described with reference to FIG. 5 to FIG. 9.

As shown in FIG. 5, Example has the smallest values of the maximum height (Rmax) and the arithmetic average roughness (Ra) and the values thereof increase in the order of Comparative Example 1 and Comparative Example 2, regardless of the accumulated-total feeding distance. In other words, it was evaluated from the surface roughness of the cut surface 92 of the workpiece 9 that Example has the highest processing accuracy and the processing accuracy is reduced in the order of Comparative Example 1 and Comparative Example 2.

Next, as shown in FIG. 6, in Example, the tool marks are evenly formed over the entirety and it is considered that, in cutting processing, a certain load is stably applied to the end mill 5 from the workpiece 9 as a cutting reaction force. In contrast, in Comparative Example 1, the tool marks are partially uneven and it is considered that a load (a contact pressure) which is applied to the end mill 5 during cutting processing as a cutting reaction force is unstable. Furthermore, in Comparative Example 2, the tool mark is unevenly formed in the entirety and it is considered that a load applied to the end mill 5 varies, and thus the load becomes more unstable even when compared to case of the Comparative Example 1. In other words, it was evaluated from the visual observation of the cut surface of the workpiece 9 that Example has the highest processing accuracy and the processing accuracy is reduced in the order of Comparative Example 1 and Comparative Example 2.

Next, as shown in FIG. 7, in Example, the angle between the cut surfaces 91 and 92 was 90.55°, which was approximately 90°. In contrast, in Comparative Example 1, the angle was 92.14°, whereas in Comparative Example 2, the angle was 91.30°. In other words, it was evaluated from the measurement of the angle of the processed corner portion that Example has the highest processing accuracy and the processing accuracy is reduced in the order of Comparative Example 2 and Comparative Example 1. Furthermore, when their cut surfaces 92 are compared, as for Comparative Example 1, a chipped-off portion 92a is observed an thus, in at least a part corresponding to the cutting edge of the end mill 5, the processing accuracy of the cut surface 92 is lower than that of Comparative Example 2. In the visual observation of the cut surface of the workpiece 9 and the processing accuracy, the comparative examples 1 and 2 are reversed. The reason for this will be described below.

As shown in FIG. 9, in Example, the abrasion area of the cutting edge of the end mill 5 was 90 μm², which was relatively small as compared with 1969 μm² of Comparative Example 1 and 117 μm² of Comparative Example 2. In other words, according to the abrasion area of the cutting edge of the end mill 5, Example has the smallest abrasion amount of the end mill 5 and the abrasion amount increases in the order of Comparative Example 2 and Comparative Example 1.

Here, in Comparative Example 1 in which the collet has the highest rigidity among Example and Comparative Examples, a large reaction force and vibration is likely to be generated in the cutting edge of the end mill 5 via the processed corner portion of the workpiece 9, and thus, the cutting edge of the end mill 5 bites into the workpiece 9 and the abrasion amount of the cutting edge increases. As a result, in the processed corner portion, as shown in FIG. 7(b) in contrast to FIG. 6, the processing accuracy is relatively lowered as compared with Comparative Example 2 such that the chipped-off portion 92a of the cut surface 92 was observed and the angle between the cut surfaces 91 and 92 became largest. However, in Comparative Example 2 in which the collet has the lowest rigidity, it is easy for the cutting edge of the end mill 5 to move backward from the workpiece 9 and the vibration of the end mill 5 is suppressed by the damping alloy, and thus, the abrasion of the cutting edge is suppressed. As a result, in the processed corner portion, as shown in FIG. 7(c) in contrast to FIG. 6, the processing accuracy is relatively higher than that of Comparative Example 1. Meanwhile, in Example, both the rigidity necessary for a collet and the absorption of the vibration of the end mill 5 were achieved with good balance, and as a result, favorable processing accuracy was achieved over the entirety of the processed surface including the processed corner portion.

According to Example in which the collet 1 in which the rod 2 made of the damping alloy is fitted and embedded is used, the vibration generated in the end mill 5 in an operation state is absorbed and mechanical strength necessary for a collet can be ensured, and thus, the processing accuracy of the workpiece 9 can be enhanced and the abrasion amount of the cutting edge of the end mill 5 can be reduced.

Hereinbefore, the representative example of the present invention is described but the present invention is not necessarily limited thereto. For example, a hexagon head bolt made of a damping alloy can be used as the rod 2. In this case, a head portion of the bolt protrudes from the body portion 10 and a shaft portion of the bolt is fitted and embedded in the long hole 19. Those skilled in the art may conceive various alternative examples and modification examples, without departing from the spirit or the appended claims of the invention.

This application is based on Japanese Patent Application (No. 2013-026476) filed on Feb. 14, 2013, and the entirety thereof is incorporated by reference.

According to the present invention, it is possible to provide a collet which has a vibration-damping function capable of enhancing processing accuracy of a workpiece to be cut and can reduce the abrasion amount of a cutting edge of a cutting tool to be used.

### DESCRIPTION OF REFERENCE NUMERALS AND SIGNS

1: collet
2: rod
3: chuck
5: end mill
10: body portion
11: flange portion
15: gripping portion

1. A collet comprising:
a cylinder-shaped body portion having a central axis, and a rod made of a damping alloy,
wherein, the cylinder-shaped body portion having the central axis has a long hole provided by drilling in a direction parallel to the central axis from an end surface on an insertion opening side through which a member to be fixed is inserted, and
wherein the rod made of a damping alloy is fitted and embedded in the long hole.

2. The collet according to claim 1,
wherein an inner circumferential surface of the long hole and an outer circumferential surface of the rod are subjected to screw-thread cutting and the rod is screwed into the long hole.

3. The collet according to claim 1,
wherein slits are provided from the end surface such that the cylinder-shaped body portion is divided at equal angles around the central axis to a plurality of gutter-shaped pieces, and
wherein, in each of the gutter-shaped pieces, the long hole is provided at the same corresponding position and the rod is given.

4. The collet according to claim 3,
wherein an odd number of the slits are provided, and
wherein, in each gutter-shaped piece, at a position symmetric with respect to an imaginary plane passing through the slit facing an inner surface thereof and the central axis, the long hole is provided and the rod is given.

5. The collet according to claim 1,
wherein the damping alloy has a component composition comprising, in a % by mass basis,
Cu: 16.9-27.7%,
Ni: 2.1-8.2%,
Fe: 1.0-2.9%, and
C: 0.05% or less,
with the balance being Mn and unavoidable impurities.
